(19) United States
(12) Patent Application Publication
(10) Pub. No.: US 2024/0056151 A1
(43) Pub. Date: Feb. 15, 2024

(54) TECHNIQUES FOR KNOWLEDGE DISTILLATION BASED MULTI-VENDOR SPLIT LEARNING FOR CROSS-NODE MACHINE LEARNING

(71) Applicant: QUALCOMM Incorporated, San Diego, CA (US)

(72) Inventors: June NAMGOONG, San Diego, CA (US); Yiyue CHEN, San Diego, CA (US); Taesang YOO, San Diego, CA (US); Abdelrahman Mohamed Ahmed Mohamed IBRAHIM, San Diego, CA (US)

(21) Appl. No.: 18/340,732

(22) Filed: Jun. 23, 2023

Related U.S. Application Data
(60) Provisional application No. 63/371,311, filed on Aug. 12, 2022.

(51) Int. Cl. H04B 7/06

(52) U.S. Cl. CPC H04B 7/0626; H04B 7/0634

(57) ABSTRACT

The techniques described herein utilize a machine learning algorithm to train the encoders from multiple UE vendors and a shared decoder from a gNB vendor in order to develop a universal gNB decoder that may be capable of decoding input from UEs from different UE vendors at comparable performance and overhead to different decoders that are specifically developed for each encoder.

### CROSS-REFERENCE TO RELATED APPLICATIONS

This application claims the benefit of U.S. Provisional Application Ser. No. 63/371,311, entitled “KNOWLEDGE DISTILLATION IN MULTI-VENDOR SPLIT LEARNING FOR CROSS-NODE ML” and filed on Aug. 12, 2021, which is expressly incorporated by reference herein in its entirety.

### BACKGROUND

### Technical Field

The present disclosure generally relates to communication systems, and more particularly, to techniques for knowledge distillation in multi-vendor split learning for cross-node machine-learning (ML).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

Therefore, there exists a need for further improvements in 5G NR technology. These improvements may also be applicable to other multi-access technologies and the telecommunication standards that employ these technologies. For instance, improvements to efficiency and latency relating to mobility of user equipments (UEs) communicating with network entities are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example aspect includes a method for training a shared base station (gNB) decoder for wireless communications utilizing machine learning (ML) algorithm. The method may comprise encoding a set of channel state information (CSI) precoding vectors via one or more teacher user equipment (UE) encoders. The method may further comprise decoding the output of the one or more teacher UE encoders by one or more gNB teacher decoders to generate a teacher reconstructed CSI vectors. The method may further comprise calculating a loss function between the teacher reconstructed CSI vectors and a ground truth value that is based on the set of CSI precoding vectors. The method may further comprise training the one or more teacher UE encoders and the one or more gNB teacher decoders based on the calculations. The method may further comprise distilling encoding functionality of the one or more teacher UE encoders into corresponding one or more student UE encoders. The method may further comprise distilling decoding functionality of the one or more gNB teacher decoders into the shared gNB decoder, wherein the shared gNB decoder is configured to decode communications received from a plurality of UEs and a plurality of wireless network providers.

Another example aspect includes an apparatus for training a shared base station (gNB) decoder for wireless communications utilizing ML algorithm, comprising one or more memories and one or more processors coupled with the one or more memories. The one or more processors, individually or in combination, may be configured to encode a set of CSI precoding vectors via one or more teacher UE encoders. The one or more processors, individually or in combination, may further be configured to decode the output of the one or more teacher UE encoders by one or more gNB teacher decoders to generate a teacher reconstructed CSI vectors. The one or more processors, individually or in combination, may further be configured to calculate a loss function between the teacher reconstructed CSI vectors and a ground truth value that is based on the set of CSI precoding vectors. The one or more processors, individually or in combination, may further be configured to train the one or more teacher UE encoders and the one or more gNB teacher decoders based on the calculations. The one or more processors, individually or in combination, may further be configured to distil encoding functionality of the one or more teacher UE encoders into corresponding one or more student UE encoders. The one or more processors, individually or in combination, may further be configured to distil decoding functionality of the one or more gNB teacher decoders into the shared gNB decoder, wherein the shared gNB decoder is configured to decode communications received from a plurality of UEs and a plurality of wireless network providers.

Another example includes an apparatus for wireless communication by a user equipment, comprising means for training a shared gNB decoder for wireless communications utilizing ML algorithm. The apparatus may comprise means for encoding a set of CSI precoding vectors via one or more teacher UE encoders. The apparatus may further comprise means for decoding the output of the one or more teacher UE encoders by one or more gNB teacher decoders to generate a teacher reconstructed CSI vectors. The apparatus may further comprise means for calculating a loss function between the teacher reconstructed CSI vectors and a ground truth value that is based on the set of CSI precoding vectors. The apparatus may further comprise means for training the one or more teacher UE encoders and the one or more gNB teacher decoders based on the calculations. The apparatus may further comprise means for distilling encoding functionality of the one or more teacher UE encoders into corresponding one or more student UE encoders. The apparatus may further comprise means for distilling decoding functionality of the one or more gNB teacher decoders into the shared gNB decoder, wherein the shared gNB decoder is configured to decode communications received from a plurality of UEs and a plurality of wireless network providers.

Another example includes one or more non-transitory computer readable mediums, individually or in combination, storing instructions, executable by one or more processors, for training a shared gNB decoder for wireless communications utilizing ML algorithm. The instructions, executable by the one or more processors, include instructions for encoding a set of CSI precoding vectors via one or more teacher UE encoders. The instructions are further executable by the one or more processors for decoding the output of the one or more teacher UE encoders by one or more gNB teacher decoders to generate a teacher reconstructed CSI vectors. The instructions are further executable by the one or more processors for calculating a loss function between the teacher reconstructed CSI vectors and a ground truth value that is based on the set of CSI precoding vectors. The instructions are further executable by the one or more processors for training the one or more teacher UE encoders and the one or more gNB teacher decoders based on the calculations. The instructions are further executable by the one or more processors for distilling encoding functionality of the one or more teacher UE encoders into corresponding one or more student UE encoders. The instructions are further executable by the one or more processors for distilling decoding functionality of the one or more gNB teacher decoders into the shared gNB decoder, wherein the shared gNB decoder is configured to decode communications received from a plurality of UEs and a plurality of wireless network providers.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B is a diagram illustrating an example of disaggregated base station architecture, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is an example of call flow between a plurality of UE vendor servers and a gNB vendor in accordance with various aspects of the present disclosure.

FIG. 4 is a diagram of an example multiple UE vendor encoders a shared gNB decoder with trained networks deployed in the wireless communication network in accordance with various aspects of the present disclosure.

FIG. 5A is a diagram of the first step of the knowledge-distillation based training, where the teacher encoders and the teacher decoders are trained in accordance with various aspects of the present disclosure.

FIG. 5B is a diagram of the second step of the knowledge-distillation based training, where the student encoders and shared decoder are trained in accordance with various aspects of the present disclosure.

FIG. 5C is diagram as follow-on step for the knowledge-distillation based training, where the student encoders and shared decoder are trained in accordance with various aspects of the present disclosure.

FIG. 6 is a schematic diagram of an example implementation of various components of a processing system in accordance with various aspects of the present disclosure.

FIG. 7 is a flow diagram of an example of a method of wireless communication implemented by the processing system in accordance with aspects of the present disclosure.

### DETAILED DESCRIPTION

In cross-node machine learning (ML), a neural network (NN) may be split into two portions: the encoder on a user equipment (UE) and decoder on the base station (gNB). The encoder output from the UE may be transmitted to the gNB as an input to the decoder. In one example, the encoder at a UE outputs a compressed channel state information (CSI), which may be input to the decoder at the gNB. In turn, the decoder at the gNB may output a reconstructed CSI, such as precoding vectors.

In real-world wireless communications systems, the networks include UEs and gNBs in operation from any number of different wireless network providers. For purposes of the present disclosure, the “wireless network providers” may be used interchangeably with “wireless network vendors” or “vendors” to refer to manufacturers and providers of equipment used in wireless network systems such as base stations and/or modems for UEs that may be implemented in real-world situations by different companies. Each wireless network provider may have unique encoders for the UE, and therefore require a unique decoder for the gNB. Multiple decoders at gNB to process input from different types of encoders may require additional system capabilities that may negatively impact the system performance. Therefore, there exists a need for a “universal” gNB decoder that may be capable of decoding input from any number of different wireless network provider UEs without sacrificing the processing time or speed achieved via an otherwise customizable or unique decoder that is typically utilized today for different vendors.

However, developing a “universal” gNB decoder, or a “shared” gNB decoder that may be common across multiple vendors has challenges. Typically, it has been challenging to train one shared decoder that achieves the optimal performance when paired with each of the UE encoders from multiple UE vendors, especially if the encoders participating in the training session are heterogenous in terms of architecture and model complexity. The reason for such challenges arises because a less powerful encoder dominates the learning signal for the shared decoder during training, and hence degrades the performance of more powerful encoders.

The techniques described herein utilize a machine learning algorithm to train the encoders and decoders from multiple wireless network providers in order to develop a universal gNB decoder that may be capable of decoding input from different wireless network providers at comparable performance and overhead to different decoders that are specifically developed for each encoder. Since the operation of CSI reporting based on cross node ML involve different neural networks from multiple wireless network providers, multiple vendors may participate in the ML training to optimize their models together. As multiple vendors may participate in the ML training, this ML training may be referred to as “multi-vendor training” or “multi-network training” system.

In a multi-vendor training system described herein, each wireless network provider (e.g., UE vendor and gNB vendor) may utilize its own servers that separately participate in offline training. The one or more UE vendor servers may communicate with corresponding one or more gNB vendor servers during the training using a server-to-server connections. Each UE vendor server may train the UE vendor neural network (NN) (e.g., encoder). Similarly, each gNB vendor server may train its own NN (e.g., decoder). To allow joint training of encoder(s) and decoder(s), each UE vendor server may provide the ground truth output for the decoder to each gNB vendor server. UE vendor servers and gNB vendor servers may then exchange gradients and activation.

In some examples, each UE vendor server may include a teacher encoder and a student encoder, where the student encoder may be deployed to its UE's once trained. Similarly, the gNB vendor may have a teacher decoder that may be paired with a teacher encoder of each UE vendor server, and one shared decoder that may be paired with all the student encoders. With such implementation and as part of the first step in the process, techniques provided herein disclose one-to-one training of a teacher encoder-decoder pair corresponding to each UE vendor. Each UE vendor server together with gNB vendor server may train their teacher encoder-decoder pair to convergence. And as part of step two, the neural network parameters of the teacher encoders and teacher decoders may be frozen and the knowledge-distillation based training of the student encoders and the shared decoder is performed. To achieve this, the loss function may include regularization term to encourage student encoder-shared decoder pair to mimic the teacher outputs. Since the shared decoder takes the role of a student in the knowledge distillation process, the term “student decoder” may be used interchangeably with the term “shared decoder”.

Particularly, each UE vendor server may send its outputs (i.e. activation) from the last layer of its NN (i.e. encoder) to the gNB vendor server. The gNB vendor server may input the received activation from each UE vendor server to its NN (i.e. decoder). Each UE vendor server also sends the ground truth output for the decoder to the gNB vendor server. The loss function may then be computed at the gNB vendor server based on the ground truth output provided by each UE vendor server. The gNB vendor server may backpropagate the gradients to the input of its NN (i.e. decoder). The gradients at the input of the gNB vendor server NN (i.e. decoder) may then be sent to the UE vendor servers. In turn, each UE vendor server backpropagates the gradients to the input to its NN (i.e. encoder). By implementing knowledge distillation in multi-vendor split learning for cross-node ML, the techniques described here and elaborated more below, may allow development of a universal gNB that can be incorporated into gNBs to process encoded data transmitted by various UE encoders without requiring a unique decoder for each corresponding UE vendor. Such systems would reduce hardware costs for gNBs.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium(s). Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

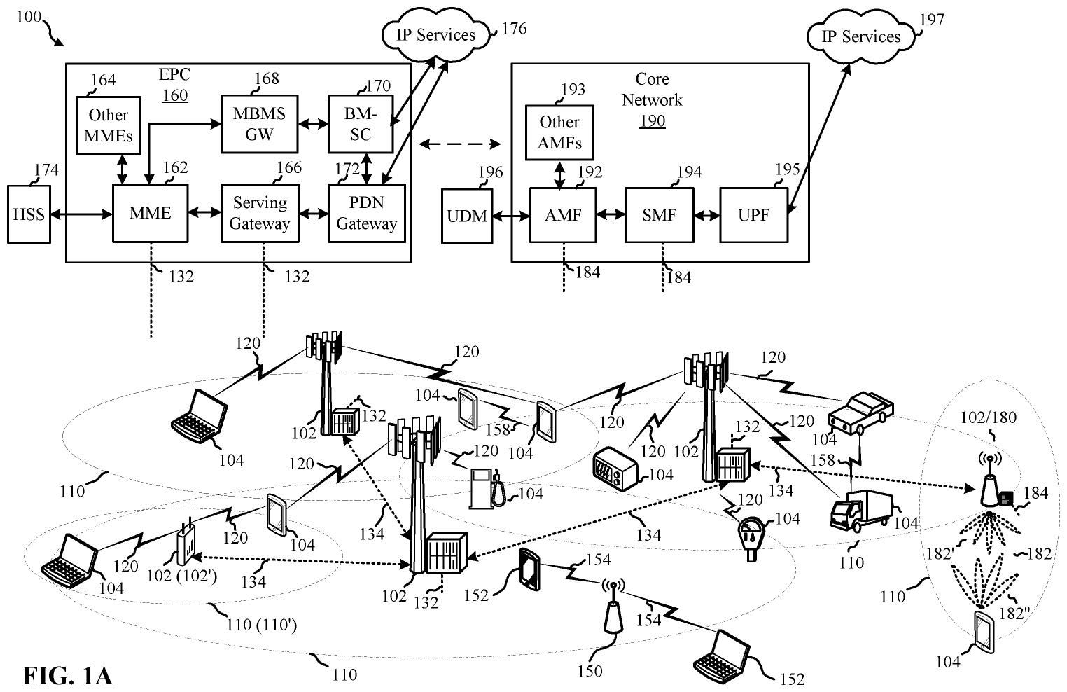

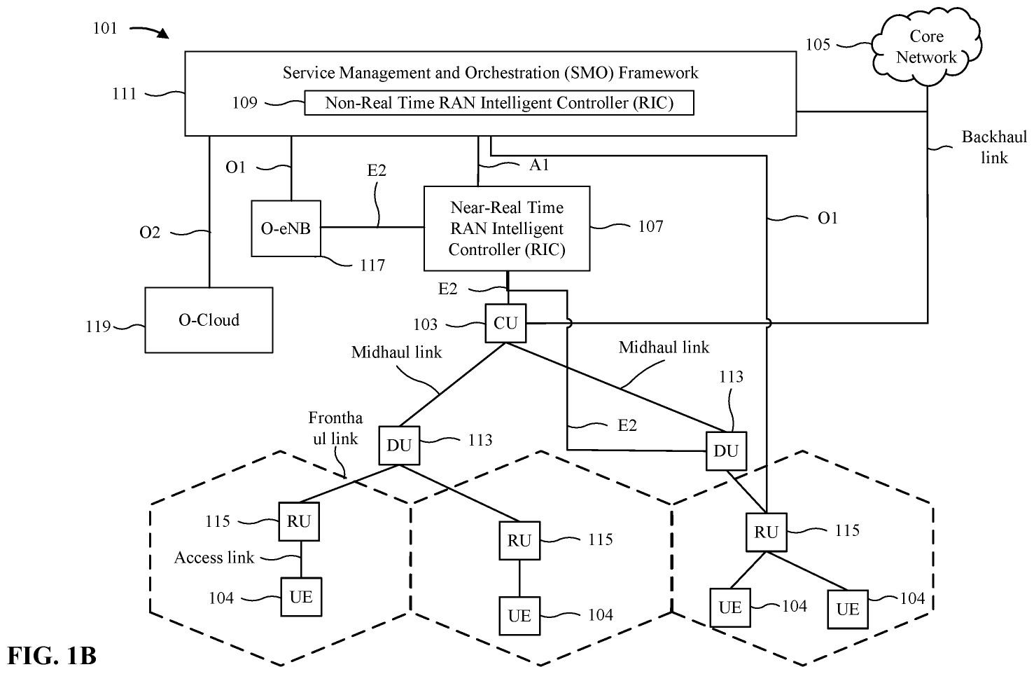

FIG. 1A is a diagram illustrating an example of a wireless communications system 100 (also referred to as a wireless wide area network (WWAN)) that includes base stations 102 (also referred to herein as network entities), user equipment(s) (UE) 104, an Evolved Packet Core (EPC) 160, and another core network 190 (e.g., a 5G Core (5GC)).

The base stations (or network entities) 102 may include macrocells (high power cellular base station) and/or small cells (low power cellular base station). The macrocells include base stations. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Any of the disaggregated components in the D-RAN and/or O-RAN architectures may be referred to herein as a network entity.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a network entity, gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB 1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 1B is a diagram illustrating an example of disaggregated base station 101 architecture, any component or element of which may be referred to herein as a network entity. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUs) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUs 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit-User Plane (CU-UP)), control plane functionality (i.e., Central Unit-Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-eNB) 117, via an O1 interface. Additionally, in some implementations, the SMO Framework 111 can communicate directly with one or more RUs 115 via an O1 interface. The SMO Framework 111 also may include a Non-RT RIC 109 configured to support functionality of the SMO Framework 111.

The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an A1 interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as A1 policies).

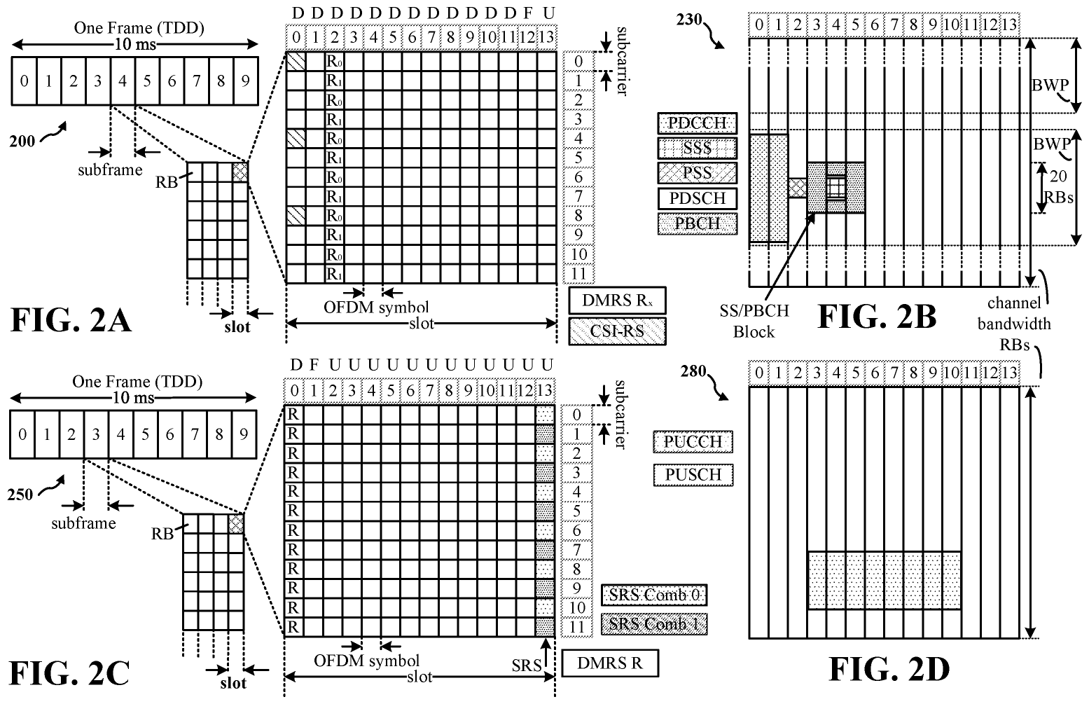

FIGS. 2A-2D are diagrams of various frame structures, resources, and channels used by UEs 104 and base stations 102/180 for communication. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology it, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

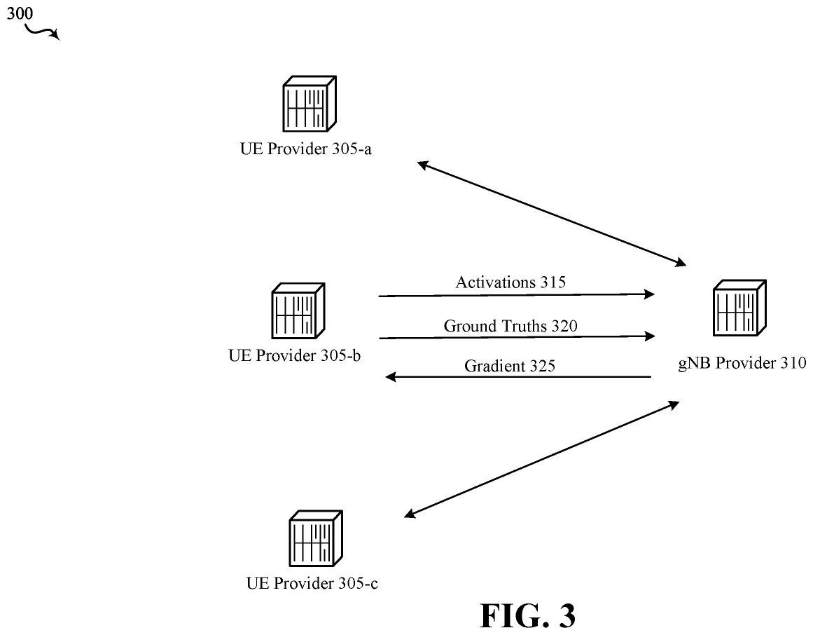

FIG. 3 is an example of call flow between a plurality of UE vendor servers 305 and a gNB vendor server 310. As noted above, in a multi-vendor training system, each wireless network provider (e.g., UE vendor and gNB vendor) may utilize its own servers that participate in the offline training session. The one or more UE vendor servers may communicate with corresponding one or more gNB vendor servers during the training using a server-to-server connections.

Thus, as illustrated in FIG. 3, each UE vendor may have a corresponding UE vendor server 305. Each gNB vendor may also have a corresponding gNB vendor server 310. The UE vendor servers 305 and gNB vendor servers 310 may participate in the same ML training session in order to train the encoders of the plurality of UE vendor servers 305 and the decoders of the gNB vendor server 310. To allow joint training of encoder(s) and decoder(s), each UE vendor server may provide the ground truth output for the decoder to each gNB vendor server. UE vendor servers and gNB vendor servers may then exchange gradients and activation.

Particularly, each UE vendor server 305 may send its outputs (i.e. activation) 315 from the last layer of its NN (i.e. encoder) to the gNB vendor server 310. The gNB vendor server 310 may input the received activation from each UE vendor server 305 to its NN (i.e. decoder). Each UE vendor server 305 may also send the ground truth output 320 for the decoder to the gNB vendor server 310. “Ground truth” in machine learning may refer to information that is known to be real or true or desired, provided by direct observation and measurement (i.e. empirical evidence) as opposed to information provided by inference. Thus, the term “ground truthing” may refer to the process of gathering the proper objective (provable) data for this test.

The loss function may then be computed at the gNB vendor server based on the desired ground truth output 320 provided by each UE vendor server. The “loss function” measures the how far (or close) an estimated value from the ML model is from its true or desired value. The gNB vendor server 310 may then backpropagate (e.g., backward propagation of the gradients for its NN parameters with respect to the loss function that quantifies the errors) the gradients to the input of its NN (i.e. decoder). The gradients 325 at the input of the gNB vendor server NN (i.e. decoder) may then be sent to the UE vendor servers 305. In ML, a “gradient” may be a derivative of a function that has more than one input variable. Thus, gradients measure the change in weights to reduce the error that is quantified by the loss function. In turn, each UE vendor server 305 backpropagates the gradients to the input to its NN (i.e. encoder).

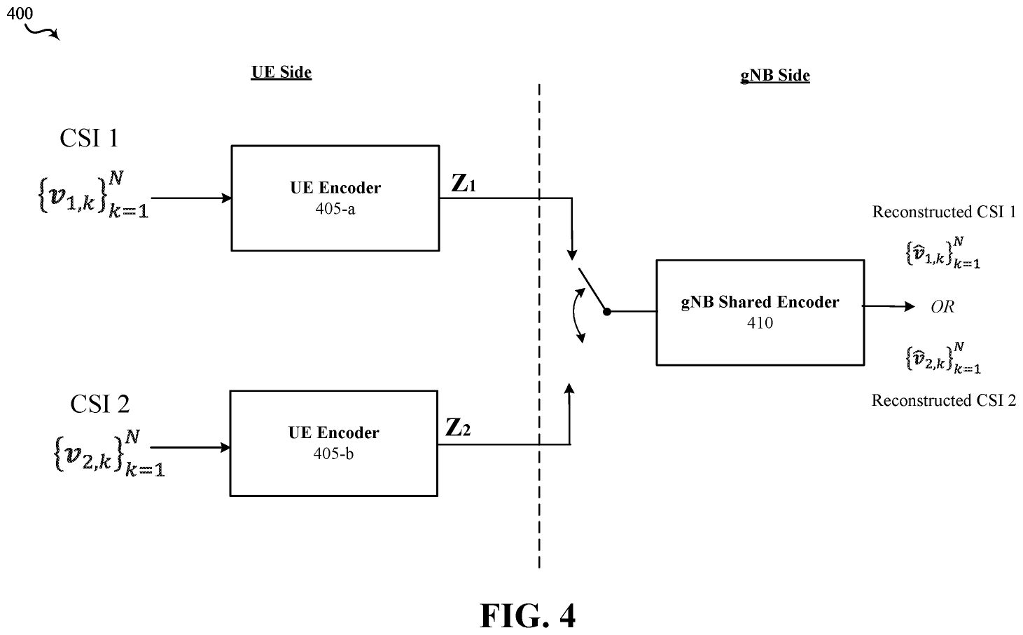

FIG. 4 is a diagram 400 of an example multiple UE vendor encoders 405 a shared gNB decoder 410 with trained networks deployed in the wireless communication network. An example implementation illustrates an operation when the neural networks are deployed with multiple UEs 104 from multiple wireless network UE vendors (e.g., first set of UEs 104 associated with a first UE vendor and a second set of UEs 104 associated with a second UE vendor) transmit CSI feedbacks to a gNB 102/180. The gNB 102/180 may be part of single gNB vendor and include a shared decoder 410 to process CSI feedback messages from a plurality of UE encoders 405 associated with a plurality of UE vendors.

As such, the UE, (e.g., first and second UEs 104) may each send the latent vectors z, to the gNB 102/180. (The index i=1 denotes the first UE, and i=2 denotes the second UE) The gNB 102/180 may utilize a shared decoder (i.e. a universal decoder) 410 that may be common to all the UEs 104 across plurality of vendors in order to process received information. Development of the “universal” gNB decoder that may be common across multiple vendors and platforms leverages the ML algorithms and knowledge-distillation based training that distills knowledge learned by the teacher encoders and teacher decoders into the student encoders and shared student decoder.

Particularly, each wireless network provider (e.g., UE vendor and gNB vendor) may utilize its own servers that participate together in offline training. The one or more UE vendor servers may communicate with corresponding one or more gNB vendor servers during the training using a server-to-server connections. Each UE vendor servers may train the UE vendor neural network (NN) (e.g., encoder). Similarly, each gNB vendor server may train its own NN (e.g., decoder). To allow joint training of encoder(s) and decoder(s), each UE vendor server may provide the ground truth output for the decoder to each gNB vendor server. UE vendor servers and gNB vendor servers may then exchange gradients and activation.

In some examples, each UE vendor server may include a teacher encoder and a student encoder, where the student encoder may be deployed once trained to its UE's. Similarly, the gNB vendor server may have a teacher decoder that may be paired with a teacher encoder of each UE vendor server, and one shared decoder that may be paired with all the student encoders. With such implementation and as part of the first step in the process, techniques provided herein disclose one-to-one training of a teacher encoder-decoder pair corresponding to each UE vendor. Each UE vendor server together with gNB vendor server may train their teacher encoder-decoder pair to convergence. And as part of step two, the neural network parameters of the teacher encoders and the teacher decoders may be frozen, and the knowledge-distillation based training of the student encoders and the shared decoder is performed. To achieve this, the loss function may include regularization term to encourage the student encoder-shared decoder pair to mimic the teacher outputs.

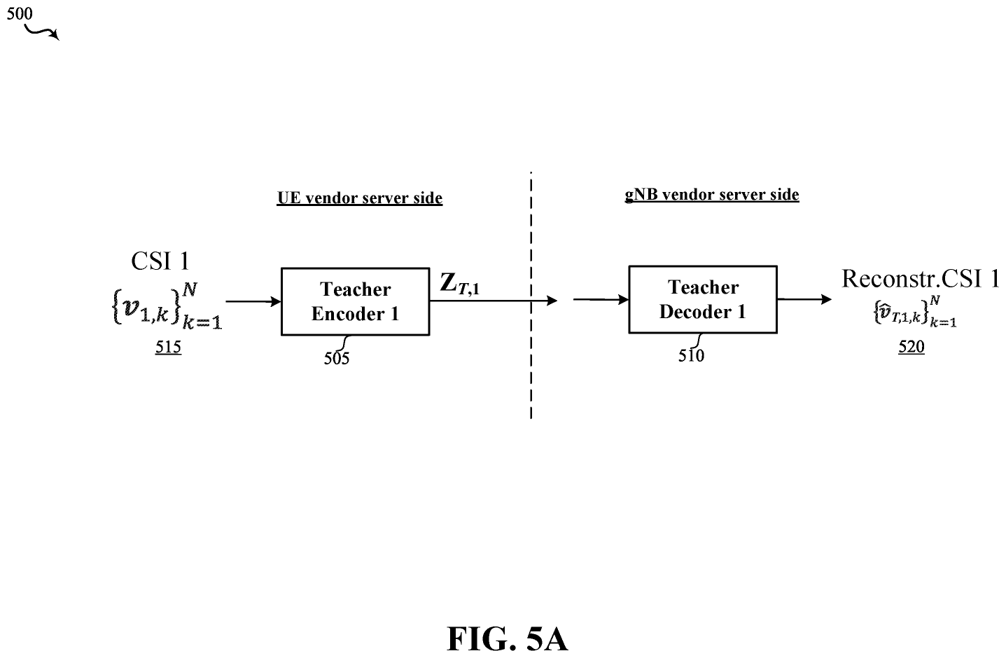

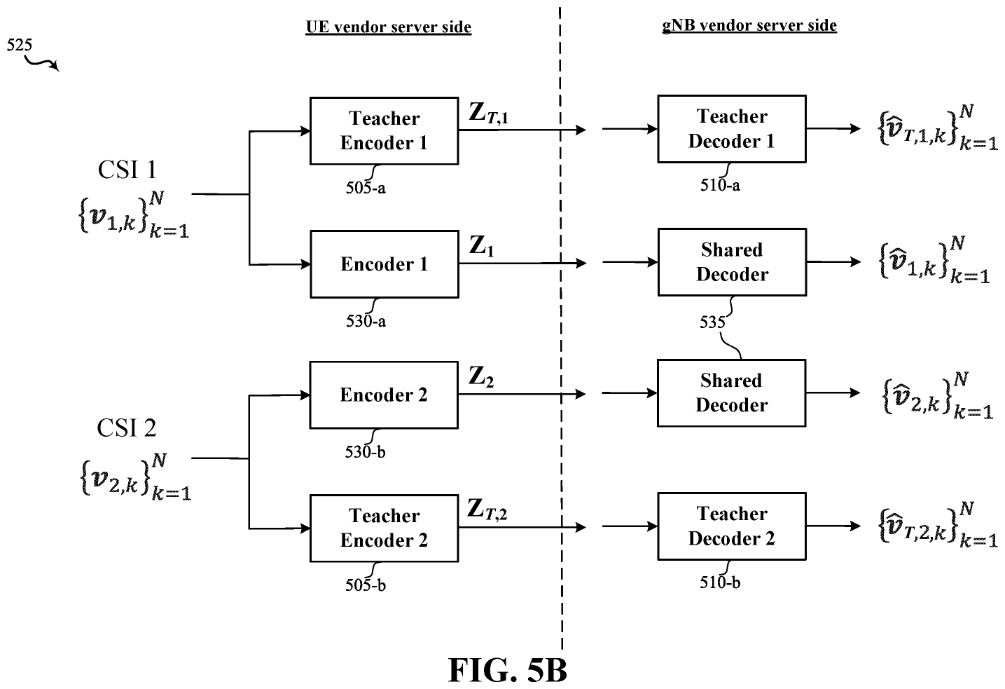

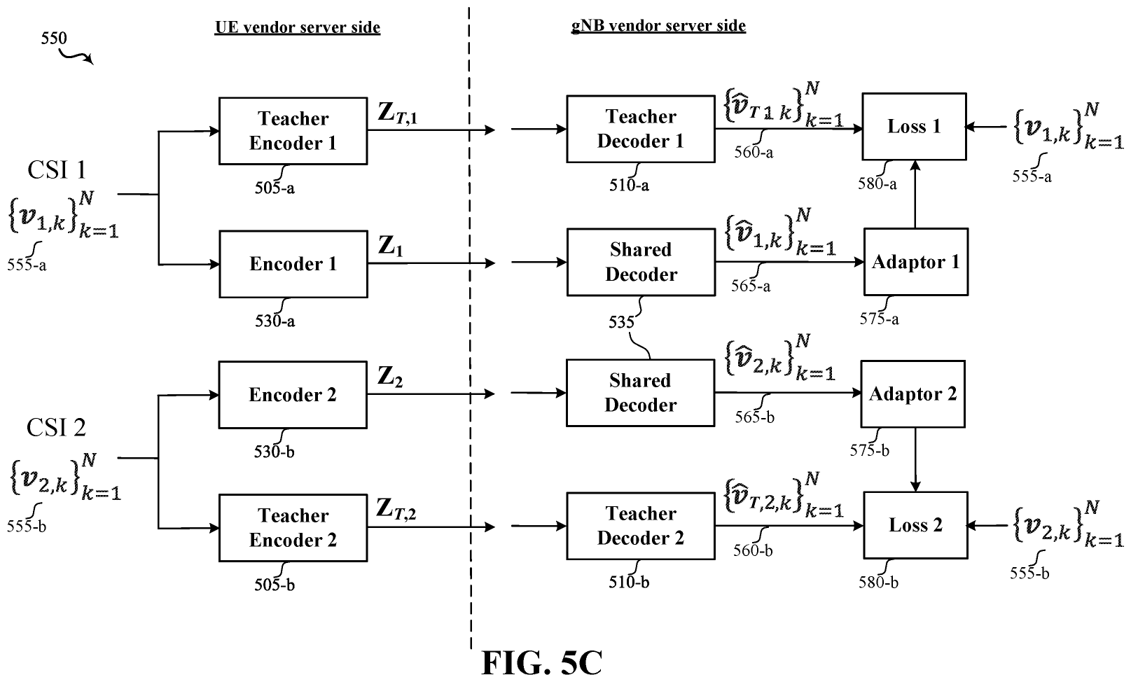

FIG. 5A is a diagram 500 of the first step of the knowledge-distillation based training, where the teacher encoders and teacher decoders are trained. In some examples, the first UE vendor and the first gNB vendor may train the corresponding first teacher encoder-decoder pair (e.g., first teacher encoder 505 and first teacher decoder 510). Although, FIG. 5A discloses only a single encoder-decoder pair, it should be appreciated by those of ordinary skill in the art that the same process disclosed herein for training teacher encoder-decoder pair may be carried out for any number of encoder-decoder pairs corresponding to different wireless network providers/vendors.

The input to the teacher encoder 505 may be CSI that may include the set of ground truth precoding vectors 515. The output 520 of the teacher decoder 510 may be a set of reconstructed precoding vectors from the teacher decoder 510. In some examples, the teacher encoder 505 of the first UE vendor may have the same architecture as the student encoder of the first UE vendor that the UE vendor server for the first UE vendor may download to the UE's of the first UE vendor. The teacher decoder 510 of the gNB vendor may have the same architecture as the shared decoder of the gNB vendor that the gNB vendor server for the gNB vendor may download to the gNB's of the gNB vendor. For the purpose of training the teacher encoder-decoder, the teacher decoder may employ a loss function that attempts to align the direction of v_{1,k} 515 (e.g., input to the teacher encoder 505) with that of \hat{v}_{T,1,k} 520 (e.g., output of the teacher decoder 510). One example is Σₖ₌₁^{N}(∥v_{1,k}∥²+∥\hat{v}_{T,1,k}∥²−2|\hat{v}_{T,1,k}^{H}v_{1,k}|), where N is the number of CSI vectors. The process may be repeated for any number of encoder-decoder pairs corresponding to different wireless network vendors.

FIG. 5B is a diagram 525 of the second step of the knowledge-distillation based training, where the student encoders and student decoders are trained. As part of the second step of the knowledge-distillation based training, the method may include freezing the neural network parameters of the teacher encoder-decoder pairs (e.g., first teacher encoder 505-a and a first teacher decoder 510-a associated with a first wireless network provider, and second teacher encoder 505-b and a second teacher decoder 510-b associated with a second wireless network provider) after the teacher encoder-decoder pairs have been trained as part of the first step (FIG. 5A).

The system may then implement student encoders (e.g., first student encoder 530-a associated with a first wireless network provider and a second student encoder 530-b associated with a second wireless network provider). A shared student decoder 535 may be trained to decode outputs from the first student encoder 530-a and second student encoder 530-b) and comparing the results with the teacher decoders 510. It should be appreciated that although FIG. 5B illustrates the shared student decoder 535 as separate elements, the shared student decoder 535 may be a single decoder where the input to the shared decoder 535 switches between the outputs from the first student encoder 530-a and second student encoder 530-b.

FIG. 5C is diagram 550 as follow-on step for the knowledge-distillation based training, where the student encoders and student decoders are trained. In some examples, the CSI vectors 555 (e.g., first CSI vectors 555-a and second CSI vectors 555-b) may be input into the corresponding teacher encoder 505 and the student encoder 530. For example, at the first UE vendor server, the first CSI vectors 555-a may be input into the first teacher encoder 505-a and the first student encoder 530-a. At the second UE vendor server, the second CSI vectors 555-b may be input into the second teacher encoder 505-b and the second student encoder 530-b. The outputs of the encoders may be sent to gNB vendor server(s)

At the gNB vendor server-side, the first teacher decoder 510-a may decode the output of the first teacher encoder 505-a received from the first UE vendor server. The student shared decoder 535 may also decode the output of the first student encoder 530-a. The second teacher decoder 510-b may decode the output of the second teacher encoder 505-b received from the second UE vendor server. And student shared decoder 535 may also decode the output of the second student encoder 530-b.

Based on the decoding from each of the teacher decoders 510 and the student shared decoder 535, a loss function 580 may be measured for back-propagation. The loss function, as noted above, may be sum of the loss for each UE vendor server The loss function 580 may be computed using the ground truth (e.g., the true value of the input 555 that was originally input into each of teacher encoders 505 and student encoders 530), the student reconstructed CSI 565 for the student encoder of the UE vendor server, and the teacher reconstructed CSI 560 for the teacher encoder. The loss function for each UE vendor server comprises the reconstruction loss for each UE vendor, which can be expressed as Σₖ₌₁^{N}(∥v_{i,k}∥²+∥\hat{v}_{i,k}∥²−2|\hat{v}_{i,k}^{H}v_{i,k}|), and the knowledge distillation loss for each UE vendor, which may be expressed as Σₖ₌₁^{N}∥Aᵢ\hat{v}_{i,k}−\hat{v}_{T,i,k}∥².

Thus, the reconstructed loss may represent the similarity between the student reconstructed CSI 565 (e.g., output of the shared decoder 535) and ground truth parameter 555 (e.g., original input). The knowledge distillation loss may be calculated based on similarity between a linear transformed version of the student reconstructed CSI 565 and the teacher reconstructed CSI 560 for the UE vendor. The linear transformation that is performed by a linear layer Aᵢ may be referred to as the “adaptor.” The adaptor can be implemented by a linear layer.

Accordingly, based on the reconstructed loss and the knowledge distillation loss, the weights and biases for the student encoders and the shared decoder may be continuously adjusted in order for the shared decoder output to mimic the output of the teacher decoders 510, as well as the ground truth 555 throughout the ML training session. And upon completion of the ML training of the student encoders 530 and the shared decoder 535, the servers will download the corresponding information to a vendor's respective devices. For example, a server for the gNB vendor may download the shared decoder 535 to the gNB's 102 for the gNB vendor, a first UE vendor server for a first UE vendor may download first student encoder 530a to the UEs for the first UE vendor, a second UE vendor server for a second UE vendor may download second student encoder 530b to the UEs for the second UE vendor, and so on

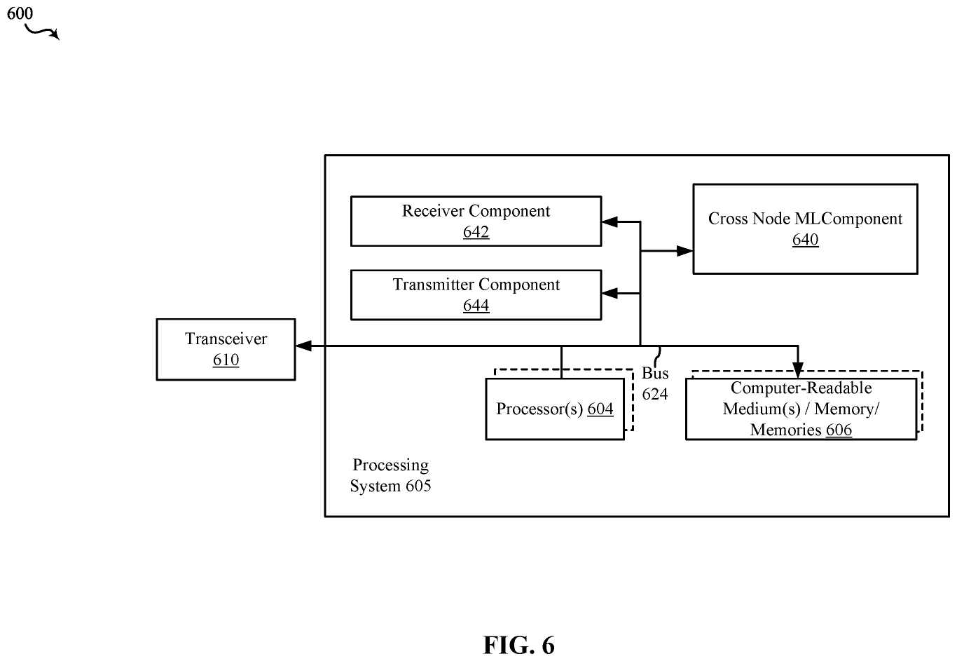

FIG. 6 is a diagram 600 illustrating an example of a hardware implementation for a processing system 605 to implement the machine learning algorithm to train the encoders and decoders from multiple wireless network providers in order to develop a universal gNB decoder that may be capable of decoding input from different wireless network providers at comparable performance and overhead to different decoders that are developed for each encoder. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware components, represented by the processor(s) 604, the cross node ML component 640, and the computer-readable medium(s)/memory/memories 606. The bus 624 may also link various other circuits such as timing sources, peripherals, voltage regulators, and power management circuits, which are well known in the art, and therefore, will not be described any further.

The processing system 614 may be coupled with a transceiver 610. The transceiver 610 is coupled with one or more antennas 620 to receive and transmit information. The transceiver 610 provides a means for communicating with various other apparatus over a transmission medium. The transceiver 610 receives a signal from the one or more antennas 620, extracts information from the received signal, and provides the extracted information to the processing system 614, specifically the receiver component 642. The receiver component 642 may receive the application traffic 606 and the optimization requests 636. In addition, the transceiver 610 receives information from the processing system 614, specifically the transmitter component 644, and based on the received information, generates a signal to be applied to the one or more antennas 620.

The processing system 614 includes a processor 1104 coupled with a computer-readable medium(s)/memory/memories 606 (e.g., a non-transitory computer readable medium). The processor(s) 604 is responsible for general processing, including the execution of software stored on the computer-readable medium(s)/memory/memories 606. The software, when executed by the processor(s) 604, causes the processing system 614 to perform the various functions described supra for any particular apparatus. The computer-readable medium(s)/memory/memories 606 may also be used for storing data that is manipulated by the processor(s) 604 when executing software. The processing system 614 further includes the cross node ML component 640. The aforementioned components may be software components running in the processor(s) 604, resident/stored in the computer readable medium(s)/memory/memories 606, one or more hardware components coupled with the processor(s) 604, or some combination thereof.

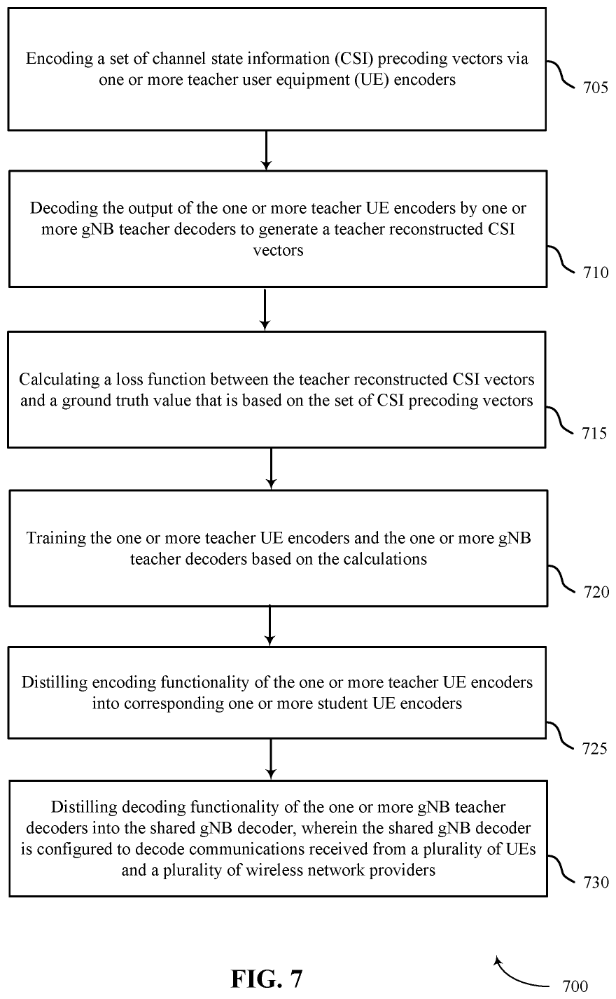

Referring to FIG. 7, an example method 700 for wireless communications in accordance with aspects of the present disclosure may be performed by one or more processing system 605 discussed with reference to FIG. 6. Although the method 700 is described below with respect to the elements of the processing system 605, other components may be used to implement one or more of the steps described herein, including servers and network entities.

At block 705, the method 700 may include encoding a set of channel state information (CSI) precoding vectors via one or more teacher user equipment (UE) encoders. In some examples, the method of block 705 may be performed by the processor(s) 604, the cross node ML component 640 in and/or one or more other components or subcomponents of the processing system 605. In certain implementations, the processor(s) 604, the cross node ML component 640 in and/or one or more other components or subcomponents of the processing system 605 may be configured to and/or may define means for encoding a set of channel state information (CSI) precoding vectors via one or more teacher user equipment (UE) encoders.

At block 710, the method 700 may include decoding the output of the one or more teacher UE encoders by one or more gNB teacher decoders to generate a teacher reconstructed CSI vectors. In some examples, the method of block 710 may be performed by the processor(s) 604, the cross node ML component 640 in and/or one or more other components or subcomponents of the processing system 605. In certain implementations, the processor(s) 604, the cross node ML component 640 in and/or one or more other components or subcomponents of the processing system 605 may be configured to and/or may define means for decoding the output of the one or more teacher UE encoders by one or more gNB teacher decoders to generate a teacher reconstructed CSI vectors.

At block 715, the method 700 may include calculating a loss function between the teacher reconstructed CSI vectors and a ground truth value that is based on the set of CSI precoding vectors. In some examples, the method of block 715 may be performed by the processor(s) 604, the cross node ML component 640 in and/or one or more other components or subcomponents of the processing system 605. In certain implementations, the processor(s) 604, the cross node ML component 640 in and/or one or more other components or subcomponents of the processing system 605 may be configured to and/or may define means for calculating a loss function between the teacher reconstructed CSI vectors and a ground truth value that is based on the set of CSI precoding vectors.

At block 720, the method 700 may include training the one or more teacher UE encoders and the one or more gNB teacher decoders based on the calculations. In some examples, the method of block 720 may be performed by the processor(s) 604, the cross node ML component 640 in and/or one or more other components or subcomponents of the processing system 605. In certain implementations, the processor(s) 604, the cross node ML component 640 in and/or one or more other components or subcomponents of the processing system 605 may be configured to and/or may define means for training the one or more teacher UE encoders and the one or more gNB teacher decoders based on the calculations.

At block 725, the method 700 may include distilling encoding functionality of the one or more teacher UE encoders into corresponding one or more student UE encoders. In some examples, the method of block 730 may be performed by the processor(s) 604, the cross node ML component 640 in and/or one or more other components or subcomponents of the processing system 605. In certain implementations, the processor(s) 604, the cross node ML component 640 in and/or one or more other components or subcomponents of the processing system 605 may be configured to and/or may define means for distilling encoding functionality of the one or more teacher UE encoders into corresponding one or more student UE encoders.

At block 730, the method 700 may include distilling decoding functionality of the one or more gNB teacher decoders to the shared gNB decoder, wherein the shared gNB decoder is configured to decode communications received from a plurality of UEs and a plurality of wireless network providers. In some examples, the method of block 730 may be performed by the processor(s) 604, the cross node ML component 640 in and/or one or more other components or subcomponents of the processing system 605. In certain implementations, the processor(s) 604, the cross node ML component 640 in and/or one or more other components or subcomponents of the processing system 605 may be configured to and/or may define means for distilling decoding functionality of the one or more gNB teacher decoders to the shared gNB decoder, wherein the shared gNB decoder is configured to decode communications received from a plurality of UEs and a plurality of wireless network providers. In some examples, distilling the decoding functionality to the shared gNB decoder and the encoding functionality to the student UE encoders includes freezing teacher parameters during the student training.

In some examples, distilling decoding functionality of the one or more gNB teacher decoders to the shared gNB decoder, and distilling encoding functionality of the one or more UE teacher encoders to the corresponding one or more UE student encoders may comprise calculating a reconstruction loss between a student reconstructed CSI vectors that are output from the shared gNB decoder against a ground truth value to determine a similarity between the ground truth value and the student reconstructed CSI. The method may also include calculating a knowledge distillation loss based on similarity between a linear transformed version of the student reconstructed CSI value and a teacher reconstructed CSI value from the corresponding teacher decoder. Further, the method may include adjusting one or more parameters of the shared gNB decoder and one or more parameters of the student UE encoders in order to align the student reconstructed CSI value with the teacher reconstructed CSI value and the ground truth.

### Some Further Example Clauses

The following examples are illustrative only and may be combined with aspects of other embodiments or teachings described herein, without limitation.

1. A method for training a shared base station (gNB) decoder for wireless communications utilizing machine learning (ML) algorithm, comprising:
encoding a set of channel state information (CSI) precoding vectors via one or more teacher user equipment (UE) encoders;
decoding an output of the one or more teacher UE encoders by one or more gNB teacher decoders to generate teacher reconstructed CSI vectors;
calculating a loss function between the teacher reconstructed CSI vectors and a ground truth value that is based on the set of CSI precoding vectors;
training the one or more teacher UE encoders and the one or more gNB teacher decoders based on the calculations;
distilling encoding functionality of the one or more teacher UE encoders into corresponding one or more student UE encoders; and
distilling decoding functionality of the one or more gNB teacher decoders into the shared gNB decoder, wherein the shared gNB decoder is configured to decode communications received from a plurality of UEs and a plurality of wireless network providers.
   2. The method of clause 1, wherein distilling the decoding functionality to the shared gNB decoder and the encoding functionality to the student UE encoders includes freezing teacher parameters during the student training.
   3. The method of any of the preceding clauses 1 or 2, wherein distilling decoding functionality of the one or more gNB teacher decoders into the shared gNB decoder, and distilling encoding functionality of the one or more UE teacher encoders to the corresponding one or more UE student encoders comprises:
calculating a reconstruction loss between a student reconstructed CSI vectors that are output from the shared gNB decoder against a ground truth value to determine a similarity between the ground truth value and the student reconstructed CSI.
   4. The method of clause 3, further comprising:
calculating a knowledge distillation loss based on similarity between a linear transformed version of the student reconstructed CSI value and the teacher reconstructed CSI value from the corresponding teacher decoder.
   5. The method of clause 4, further comprising:
adjusting one or more parameters of the shared gNB decoder and one or more parameters of the student UE encoders in order to align the student reconstructed CSI value with the teacher reconstructed CSI value and the ground truth value.
   6. The method of any of the preceding clauses 1-5, wherein the teacher reconstructed CSI vectors include gradients.
   7. The method of clause 6, further comprising:
exchanging gradients and activation with the one or more teacher UE encoders.
   8. The method of clause 6, wherein training the one or more teacher UE encoders and the one or more gNB teacher decoders based on the calculations further comprises:
backpropagating gradients into the shared gNB decoder.
   9. An apparatus for training a shared base station (gNB) decoder for wireless communications utilizing machine learning (ML) algorithm, comprising:
one or more memories; and
one or more processors, individually or in combination, coupled with the one or more memories and configured to:
encode a set of channel state information (CSI) precoding vectors via one or more teacher user equipment (UE) encoders;
decode an output of the one or more teacher UE encoders by one or more gNB teacher decoders to generate a teacher reconstructed CSI vectors;
calculate a loss function between the teacher reconstructed CSI vectors and a ground truth value that is based on the set of CSI precoding vectors;
train the one or more teacher UE encoders and the one or more gNB teacher decoders based on the calculations;
distil encoding functionality of the one or more teacher UE encoders into corresponding one or more student UE encoders; and
distil decoding functionality of the one or more gNB teacher decoders into the shared gNB decoder, wherein the shared gNB decoder is configured to decode communications received from a plurality of UEs and a plurality of wireless network providers.
   10. The apparatus of clause 9, wherein distilling the decoding functionality to the shared gNB decoder and the encoding functionality to the student UE encoders includes freezing teacher parameters during the student training.
   11. The apparatus of any of the preceding clauses 9 or 10, wherein the one or more processors configured to distill decoding functionality of the one or more gNB teacher decoders to the shared gNB decoder, and to distill encoding functionality of the one or more UE teacher encoders to the corresponding one or more UE student encoders are further configured to:
calculate a reconstruction loss between a student reconstructed CSI vectors that are output from the shared gNB decoder against a ground truth value to determine a similarity between the ground truth value and the student reconstructed CSI.
   12. The apparatus of clause 11, wherein the one or more processors are further configured to:
calculate a knowledge distillation loss based on similarity between a linear transformed version of the student reconstructed CSI value and the teacher reconstructed CSI value from the corresponding teacher decoders.
   13. The apparatus of clause 12, wherein the one or more processors are further configured to:
adjust one or more parameters of the shared gNB decoder and one or more parameters of the student UE encoders in order to align the student reconstructed CSI value with the teacher reconstructed CSI value and the ground truth value.
   14. The apparatus of any of the preceding clauses 9-13, wherein the teacher reconstructed CSI vectors include gradients.
   15. The apparatus of clause 14, wherein the one or more processors are further configured to:
exchange gradients and activation with the one or more teacher UE encoders.
   16. The apparatus of clause 14, wherein the one or more processors configured to train the one or more teacher UE encoders and the one or more gNB teacher decoders based on the calculations are further configured to:
backpropagate gradients into the shared gNB decoder.
   17. One or more non-transitory computer readable mediums, individually or in combination, storing instructions, executable by one or more processors each coupled to at least one of the one or more non-transitory computer readable mediums for training a shared base station (gNB) decoder for wireless communications utilizing machine learning (ML) algorithm, comprising instructions for:
encoding a set of channel state information (CSI) precoding vectors via one or more teacher user equipment (UE) encoders;
decoding an output of the one or more teacher UE encoders by one or more gNB teacher decoders to generate a teacher reconstructed CSI vectors;
calculating a loss function between the teacher reconstructed CSI vectors and a ground truth value that is based on the set of CSI precoding vectors;
training the one or more teacher UE encoders and the one or more gNB teacher decoders based on the calculations;
distilling encoding functionality of the one or more teacher UE encoders into corresponding one or more student UE encoders; and
distilling decoding functionality of the one or more gNB teacher decoders into the shared gNB decoder, wherein the shared gNB decoder is configured to decode communications received from a plurality of UEs and a plurality of wireless network providers.
   18. The one or more non-transitory computer readable mediums of clause 17, wherein distilling the decoding functionality to the shared gNB decoder and the encoding functionality to the student UE encoders includes freezing teacher parameters during the student training.
   19. The one or more non-transitory computer readable mediums of any of the preceding clauses 17 or 18, wherein distilling decoding functionality of the one or more gNB teacher decoders to the shared gNB decoder, and distilling encoding functionality of the one or more UE teacher encoders to the corresponding one or more UE student encoders comprises:
calculating a reconstruction loss between a student reconstructed CSI vectors that are output from the shared gNB decoder against a ground truth value to determine a similarity between the ground truth value and the student reconstructed CSI.
   20. The one or more non-transitory computer readable mediums of clause 19, further comprising instructions for:
calculating a knowledge distillation loss based on similarity between a linear transformed version of the student reconstructed CSI value and the teacher reconstructed CSI value from the corresponding teacher decoder.
   21. The one or more non-transitory computer readable mediums of clause 20, further comprising instructions for:
adjusting one or more parameters of the shared gNB decoder and one or more parameters of the student UE encoders in order to align the student reconstructed CSI value with the teacher reconstructed CSI value and the ground truth value.
   22. The one or more non-transitory computer readable mediums of any of the preceding clauses 17-21, wherein the teacher reconstructed CSI vectors include gradients, and wherein the one or more non-transitory computer readable mediums further comprises instructions for:
exchanging gradients and activation with the one or more teacher UE encoders.
   23. The one or more non-transitory computer readable mediums of clause 22, wherein training the one or more teacher UE encoders and the one or more gNB teacher decoders based on the calculations further comprises:
backpropagating gradients into the shared gNB decoder.
   24. An apparatus for training a shared base station (gNB) decoder for wireless communications utilizing machine learning (ML) algorithm, comprising:
means for encoding a set of channel state information (CSI) precoding vectors via one or more teacher user equipment (UE) encoders;
means for decoding an output of the one or more teacher UE encoders by one or more gNB teacher decoders to generate a teacher reconstructed CSI vectors;
means for calculating a loss function between the teacher reconstructed CSI vectors and a ground truth value that is based on the set of CSI precoding vectors;
means for training the one or more teacher UE encoders and the one or more gNB teacher decoders based on the calculations;
means for distilling encoding functionality of the one or more teacher UE encoders into corresponding one or more student UE encoders; and
means for distilling decoding functionality of the one or more gNB teacher decoders into the shared gNB decoder, wherein the shared gNB decoder is configured to decode communications received from a plurality of UEs and a plurality of wireless network providers.
   25. The apparatus of clause 24, wherein the means for distilling the decoding functionality to the shared gNB decoder and the encoding functionality to the student UE encoders includes means for freezing teacher parameters during the student training.
   26. The apparatus of any of the preceding clauses 24 or 25, wherein the means for distilling decoding functionality of the one or more gNB teacher decoders to the shared gNB decoder, and means for distilling encoding functionality of the one or more UE teacher encoders to the corresponding one or more UE student encoders comprises:
means for calculating a reconstruction loss between a student reconstructed CSI vectors that are output from the shared gNB decoder against a ground truth value to determine a similarity between the ground truth value and the student reconstructed CSI.
   27. The apparatus of clause 26, further comprising:
means for calculating a knowledge distillation loss based on similarity between a linear transformed version of the student reconstructed CSI value and the teacher reconstructed CSI value from the corresponding teacher decoder.
   28. The apparatus of clause 27, further comprising:
means for adjusting one or more parameters of the shared gNB decoder and one or more parameters of the student UE encoders in order to align the student reconstructed CSI value with the teacher reconstructed CSI value and the ground truth value.
   29. The apparatus of any of the preceding clauses 24-28, wherein the teacher reconstructed CSI vectors include gradients, and further comprising:
means for exchanging gradients and activation with the one or more teacher UE encoders.
   30. The apparatus of clause 29, wherein means for training the one or more teacher UE encoders and the one or more gNB teacher decoders based on the calculations further comprises:
means for backpropagating gradients into the shared gNB decoder.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for training a shared base station (gNB) decoder for wireless communications utilizing machine learning (ML) algorithm, comprising:
encoding a set of channel state information (CSI) precoding vectors via one or more teacher user equipment (UE) encoders;
decoding an output of the one or more teacher UE encoders by one or more gNB teacher decoders to generate teacher reconstructed CSI vectors;
calculating a loss function between the teacher reconstructed CSI vectors and a ground truth value that is based on the set of CSI precoding vectors;
training the one or more teacher UE encoders and the one or more gNB teacher decoders based on the calculations;
distilling encoding functionality of the one or more teacher UE encoders into corresponding one or more student UE encoders; and
distilling decoding functionality of the one or more gNB teacher decoders into the shared gNB decoder, wherein the shared gNB decoder is configured to decode communications received from a plurality of UEs and a plurality of wireless network providers.

2. The method of claim 1, wherein distilling the decoding functionality to the shared gNB decoder and the encoding functionality to the student UE encoders includes freezing teacher parameters during the student training.

3. The method of claim 1, wherein distilling decoding functionality of the one or more gNB teacher decoders into the shared gNB decoder, and distilling encoding functionality of the one or more UE teacher encoders to the corresponding one or more UE student encoders comprises:
calculating a reconstruction loss between a student reconstructed CSI vectors that are output from the shared gNB decoder against a ground truth value to determine a similarity between the ground truth value and the student reconstructed CSI.

4. The method of claim 3, further comprising:
calculating a knowledge distillation loss based on similarity between a linear transformed version of the student reconstructed CSI value and the teacher reconstructed CSI value from the corresponding teacher decoder.

5. The method of claim 4, further comprising:
adjusting one or more parameters of the shared gNB decoder and one or more parameters of the student UE encoders in order to align the student reconstructed CSI value with the teacher reconstructed CSI value and the ground truth value.

6. The method of claim 1, wherein the teacher reconstructed CSI vectors include gradients.

7. The method of claim 6, further comprising:
exchanging gradients and activation with the one or more teacher UE encoders.

8. The method of claim 6, wherein training the one or more teacher UE encoders and the one or more gNB teacher decoders based on the calculations further comprises:
backpropagating gradients into the shared gNB decoder.

9. An apparatus for training a shared base station (gNB) decoder for wireless communications utilizing machine learning (ML) algorithm, comprising:
one or more memories; and
one or more processors, individually or in combination, coupled with the one or more memories and configured to:
encode a set of channel state information (CSI) precoding vectors via one or more teacher user equipment (UE) encoders;
decode an output of the one or more teacher UE encoders by one or more gNB teacher decoders to generate a teacher reconstructed CSI vectors;
calculate a loss function between the teacher reconstructed CSI vectors and a ground truth value that is based on the set of CSI precoding vectors;
train the one or more teacher UE encoders and the one or more gNB teacher decoders based on the calculations;
distil encoding functionality of the one or more teacher UE encoders into corresponding one or more student UE encoders; and
distil decoding functionality of the one or more gNB teacher decoders into the shared gNB decoder, wherein the shared gNB decoder is configured to decode communications received from a plurality of UEs and a plurality of wireless network providers.

10. The apparatus of claim 9, wherein distilling the decoding functionality to the shared gNB decoder and the encoding functionality to the student UE encoders includes freezing teacher parameters during the student training.

11. The apparatus of claim 9, wherein the one or more processors configured to distill decoding functionality of the one or more gNB teacher decoders to the shared gNB decoder, and to distill encoding functionality of the one or more UE teacher encoders to the corresponding one or more UE student encoders are further configured to:
calculate a reconstruction loss between a student reconstructed CSI vectors that are output from the shared gNB decoder against a ground truth value to determine a similarity between the ground truth value and the student reconstructed CSI.

12. The apparatus of claim 9, wherein the one or more processors are further configured to:
calculate a knowledge distillation loss based on similarity between a linear transformed version of the student reconstructed CSI value and the teacher reconstructed CSI value from the corresponding teacher decoders.

13. The apparatus of claim 12, wherein the one or more processors are further configured to:
adjust one or more parameters of the shared gNB decoder and one or more parameters of the student UE encoders in order to align the student reconstructed CSI value with the teacher reconstructed CSI value and the ground truth value.

14. The apparatus of claim 9, wherein the teacher reconstructed CSI vectors include gradients.

15. The apparatus of claim 14, wherein the one or more processors are further configured to:
exchange gradients and activation with the one or more teacher UE encoders.

16. The apparatus of claim 14, wherein the one or more processors configured to train the one or more teacher UE encoders and the one or more gNB teacher decoders based on the calculations are further configured to:
backpropagate gradients into the shared gNB decoder.

17. One or more non-transitory computer readable mediums, individually or in combination, storing instructions, executable by one or more processors each coupled to at least one of the one or more non-transitory computer readable mediums for training a shared base station (gNB) decoder for wireless communications utilizing machine learning (ML) algorithm, comprising instructions for:
encoding a set of channel state information (CSI) precoding vectors via one or more teacher user equipment (UE) encoders;
decoding an output of the one or more teacher UE encoders by one or more gNB teacher decoders to generate a teacher reconstructed CSI vectors;
calculating a loss function between the teacher reconstructed CSI vectors and a ground truth value that is based on the set of CSI precoding vectors;
training the one or more teacher UE encoders and the one or more gNB teacher decoders based on the calculations;
distilling encoding functionality of the one or more teacher UE encoders into corresponding one or more student UE encoders; and
distilling decoding functionality of the one or more gNB teacher decoders into the shared gNB decoder, wherein the shared gNB decoder is configured to decode communications received from a plurality of UEs and a plurality of wireless network providers.

18. The one or more non-transitory computer readable mediums of claim 17, wherein distilling the decoding functionality to the shared gNB decoder and the encoding functionality to the student UE encoders includes freezing teacher parameters during the student training.

19. The one or more non-transitory computer readable mediums of claim 17, wherein distilling decoding functionality of the one or more gNB teacher decoders to the shared gNB decoder, and distilling encoding functionality of the one or more UE teacher encoders to the corresponding one or more UE student encoders comprises:
calculating a reconstruction loss between a student reconstructed CSI vectors that are output from the shared gNB decoder against a ground truth value to determine a similarity between the ground truth value and the student reconstructed CSI.

20. The one or more non-transitory computer readable mediums of claim 19, further comprising instructions for:
calculating a knowledge distillation loss based on similarity between a linear transformed version of the student reconstructed CSI value and the teacher reconstructed CSI value from the corresponding teacher decoder.

21. The one or more non-transitory computer readable mediums of claim 20, further comprising instructions for:
adjusting one or more parameters of the shared gNB decoder and one or more parameters of the student UE encoders in order to align the student reconstructed CSI value with the teacher reconstructed CSI value and the ground truth value.

22. The one or more non-transitory computer readable mediums of claim 17, wherein the teacher reconstructed CSI vectors include gradients, and wherein the one or more non-transitory computer readable mediums further comprises instructions for:
exchanging gradients and activation with the one or more teacher UE encoders.

23. The one or more non-transitory computer readable mediums of claim 22, wherein training the one or more teacher UE encoders and the one or more gNB teacher decoders based on the calculations further comprises:
backpropagating gradients into the shared gNB decoder.

24. An apparatus for training a shared base station (gNB) decoder for wireless communications utilizing machine learning (ML) algorithm, comprising:
means for encoding a set of channel state information (CSI) precoding vectors via one or more teacher user equipment (UE) encoders;
means for decoding an output of the one or more teacher UE encoders by one or more gNB teacher decoders to generate a teacher reconstructed CSI vectors;
means for calculating a loss function between the teacher reconstructed CSI vectors and a ground truth value that is based on the set of CSI precoding vectors;
means for training the one or more teacher UE encoders and the one or more gNB teacher decoders based on the calculations;
means for distilling encoding functionality of the one or more teacher UE encoders into corresponding one or more student UE encoders; and
means for distilling decoding functionality of the one or more gNB teacher decoders into the shared gNB decoder, wherein the shared gNB decoder is configured to decode communications received from a plurality of UEs and a plurality of wireless network providers.

25. The apparatus of claim 24, wherein the means for distilling the decoding functionality to the shared gNB decoder and the encoding functionality to the student UE encoders includes means for freezing teacher parameters during the student training.

26. The apparatus of claim 24, wherein the means for distilling decoding functionality of the one or more gNB teacher decoders to the shared gNB decoder, and means for distilling encoding functionality of the one or more UE teacher encoders to the corresponding one or more UE student encoders comprises:
means for calculating a reconstruction loss between a student reconstructed CSI vectors that are output from the shared gNB decoder against a ground truth value to determine a similarity between the ground truth value and the student reconstructed CSI.

27. The apparatus of claim 26, further comprising:
means for calculating a knowledge distillation loss based on similarity between a linear transformed version of the student reconstructed CSI value and the teacher reconstructed CSI value from the corresponding teacher decoder.

28. The apparatus of claim 27, further comprising:
means for adjusting one or more parameters of the shared gNB decoder and one or more parameters of the student UE encoders in order to align the student reconstructed CSI value with the teacher reconstructed CSI value and the ground truth value.

29. The apparatus of claim 24, wherein the teacher reconstructed CSI vectors include gradients, and further comprising:
means for exchanging gradients and activation with the one or more teacher UE encoders.

30. The apparatus of claim 29, wherein means for training the one or more teacher UE encoders and the one or more gNB teacher decoders based on the calculations further comprises:
means for backpropagating gradients into the shared gNB decoder.
